(19) United States
(12) Patent Application Publication
(10) Pub. No.: US 2009/0181203 A1
(43) Pub. Date: Jul. 16, 2009

(54) LAMINATED GLAZING AND SEALING AND PERIPHERAL REINFORCING MEANS FOR SAME

(75) Inventors: Emmanuel Valentin, Le Plessis Trevise (FR); Xavier Fanton, Aulnay Sous Bois (FR); Samuel Dubrenat, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, COURBEVOIE (FR)

(21) Appl. No.: 12/296,035

(22) PCT Filed: Apr. 4, 2007
(86) PCT No.: PCT/FR07/51073

§ 371 Date: Nov. 28, 2008

(30) Foreign Application Priority Data
Apr. 10, 2006 (FR) 0651276

(51) Int. Cl. B60J 1/00; B64C 1/14

(52) U.S. Cl. 428/38

(57) ABSTRACT

Laminated window comprising two substrates (S1, S2) between which an active system (3) is placed, characterized in that the window is provided with a first peripheral sealing means (10) for sealing the active system 3, in particular against water in vapor form, comprising at least one seal based on one or more hot-melt polymers chosen from at least one of the following polymer families: ethylene/vinyl acetate, polyisobutylene, butyl rubber and polyamide, and a second sealing means (11), especially for sealing against liquid water, this second sealing means being positioned between the substrates and peripherally with respect to the first sealing means (10).

The present invention relates to laminated windows and more particularly to those providing functionalities conferred by one or more layers and/or one or more discontinuous elements, which may be of organic, mineral or hybrid organic/mineral type. Laminated windows usually consist of two rigid substrates between which a thermoplastic polymer sheet or a superposition of such sheets is placed. The invention also includes what are called “asymmetric” laminated windows using a single rigid substrate of the glass type combined with several polymer sheets, at least one of which is generally based on polyurethane. The invention also includes laminated windows having at least one interlayer sheet based on a one-sided or two-sided adhesive polymer of the elastomer type (that is to say not requiring a lamination operation within the conventional meaning of the term, lamination generally involving heating under pressure in order to soften the thermoplastic interlayer sheet and to make it adherent).

The abovementioned layers or discontinuous elements are generally placed against one of the rigid substrates (or against the single rigid substrate), between said substrate and the polymer-based flexible sheet or one of said sheets. They may also be placed between two flexible or semi-flexible substrates which are themselves associated with a rigid substrate, or placed between two rigid substrates. They will be denoted hereafter by the term “active systems”. The window may incorporate several active systems.

The first types of active system pertinent to the invention are electrochemical systems in general, and more particularly electrically controllable systems of the window type having variable energy and/or optical properties. They also comprise photovoltaic and electroluminescent systems.

These systems have very diverse applications:

Photovoltaic cells convert solar energy into light energy.

Electrically controllable systems are used in particular to obtain windows for which it is possible to modify, at will, the darkening/degree of vision or degree of thermal/solar radiation filtration. These are for example viologen-based windows, which allow light transmission or absorption to be adjusted, such as those described in patents U.S. Pat. No. 5,239,406 and EP-612 82.

Electroluminescent systems convert electrical energy directly to light, an example being described in patent FR-2 770 222.

There are also electrochromic windows, which allow the light and thermal transmission to be modulated. They are described for example in patents EP-253 713 and EP-670 346, the electrolyte being in the form of a polymer or of a gel, and the other layers being of mineral type. Another type is described in patents EP-867 752, EP-831 360, PCT/FRO0/00675 and PCT/FR99/01653, the electrolyte this time being in the form of an essentially mineral layer, all of the layers of the system then being essentially mineral: this type of electrochromic system is commonly referred to by the term “all-solid-state” electrochromic system. There are also electrochromic systems in which all of the layers are of polymer type, which are then referred to as “all-polymer” electrochromic systems.

In general, electrochromic systems comprise two layers of electrochromic material that are separated by an electrolyte layer and flanked by two electronically conducting layers.

There are also systems called “optical valves”. These are polymer-based films in which microdroplets containing particles capable of adopting a preferential direction under the action of an electric field are placed. An example of this is described in patent WO 93/09460.

There are also liquid-crystal systems, the operating mode of which is similar to the previous systems. They use a polymer film placed between two conducting layers, droplets of liquid crystals, especially nematic liquid crystals of positive dielectric anisotropy, being dispersed in said film. When voltage is applied to the film, the liquid crystals are oriented along a preferential axis, thereby permitting vision. With no voltage applied, the film becomes scattering. Examples thereof are described in patents EP-238 164, U.S. Pat. No. 4,435,047, U.S. Pat. No. 4,806,922 and U.S. Pat. No. 4,732,456. Mention may also be made of cholesteric liquid-crystal polymers, such as those described in patent WO 92/19695.

A second type of active system pertinent to the invention relates to layers or multilayers, the properties of which are modified without a power supply owing to the effect of heat or light. Mention may be made of thermochromic layers, especially those based on vanadium oxide, thermotropic layers or photochromic layers. Within the context of the present invention and throughout the present text, the term “layer” should be taken in its widest sense. The materials that may be involved are both mineral materials and organic materials, most particularly polymers, which may be in the form of polymer films or even gel films. This is especially the case for thermotropic gels, for example those described in patents EP 639 450, U.S. Pat. No. 5,615,040, WO 94/20294 and EP 878 296.

A third type of active system pertinent to the invention relates to elements in the form of heating wires or grids or heating conducting layers, which heat by Joule heating (these may be wires embedded in the surface of the thermoplastic sheet, as described for example in the patents EP-785 700, EP-553 025, EP-506 521 and EP-496 669).

A fourth type of active system pertinent to the invention relates to layers or multilayers having solar-control or low-emissivity properties, especially those based on one or more silver layers interspersed with dielectric layers. These multilayers may be deposited on one of the rigid substrates or deposited on a flexible substrate of the PET (polyethylene terephthalate) type which is placed between two sheets of a thermoplastic polymer of the PVB (polyvinyl butyral) type to be assembled with the two rigid substrates of glass type. Examples of these are found in patents EP-638 528, EP-718 250, EP-724 955, EP-758 583 and EP-847 965.

Some of these systems require means for electrical connection to an external current source, which must be designed so as to avoid any short circuit. All these systems have in common the fact that they may be sensitive, to a greater or lesser extent, to mechanical or chemical attack, to contact with water or to exchanges with the outside.

This is why, to maintain their proper operation, these active systems are usually placed against at least one protective carrier substrate. They are usually placed between two protective substrates, for example made of glass or a rigid or semi-rigid or flexible polymer, either by direct contact therewith or via one or more assembly polymer sheets of the thermoplastic type. They usually have the laminated structure described above and are often provided with peripheral sealing means, the purpose of which is to isolate the active system from the outside as far as possible.

Such sealing means are described in French patent 2 815 374, which discloses a system of seals. This system of seals consists of a number of elements added around the periphery of the window for the purpose of isolation from gases, liquids and dust, possibly to provide mechanical reinforcement or an interface with the mounting frame (the bodywork in the case of automobile windows). The system of seals is often made up of several elements so as to provide all the functions simultaneously. As described in that patent, the system of seals combines a polyisobutylene-based seal (which is a gas barrier), called a butyl seal, with a polysulfide or polyurethane seal (which is a liquid barrier).

Moreover, in that French patent, the butyl seal is preferably placed between the two substrates, this being so for at least two reasons. Firstly, its very low glass transition temperature T_{g} gives it thermomechanical properties that are insufficient at the usual operating temperatures and the butyl seal must not be in direct contact with the external environment as there would be a risk of it being degraded, for example by tearing. Secondly, it is in contact with the inner face of each of the substrates, and this guarantees continuity of the gas barrier over the entire perimeter of the window.

This system of seals is effective for substrates of conventional thickness (of the order of a few mm) but poses problems in the case of thin substrates (with a thickness of less than 1 mm).

This is because such a rigid substrate/flexible interlayer/rigid substrate assembly may be excessively stressed mechanically during the lamination operation (which is usually carried out under pressure and generally carried out hot). The edges of the rigid substrates, in the zone where the peripheral groove of the active system lies, overhang and, under the pressure, have a tendency to bend relative to the more central portion of said substrates. Optical distortion effects will ensue, these being visible in reflection and/or in transmission.

In the case of a rigid substrate of the glass type, there is a risk of breakage. There will also be a risk of incomplete adhesion, possibly indicated by the presence of peripheral bubbles.

In addition, thin substrates do not have mechanical properties sufficient to withstand the compressive forces generated by the molds during the post-lamination encapsulation operation and run the risk of breaking on the periphery, consequently resulting in the device incorporating the active system being off-specification.

As indicated in patent FR 2 815 374, it is possible to insert mechanical reinforcement means into the butyl seal, such as steel balls or to add, on the periphery, a metal frame, but all these elements have the drawback of exhibiting thermomechanical behavior different from the lamination polymer, and therefore of increasing the risks of optical distortion or breakage. In addition, in the case of a metal frame, the latter is not laminated onto the substrates and the adhesion between the two substrates on the periphery is therefore zero.

The object of the invention is therefore to improve the design of systems of seals for the aforementioned laminated windows, especially as regards their chemical properties and/or their mechanical properties and/or their processing and/or their configuration relative to the substrates protecting the active systems.

In general, butyl rubber seals combined with silicone or polysulfide seals are used.

However, these seals are capable of being improved on several counts, since they must meet as far as possible at least three requirements that are not necessarily compatible:
as was seen, they must isolate the active system from the outside and must therefore act as a barrier as effectively as possible, especially with respect to water or any other solvent, in its vapor form and/or in its liquid form. However, the seals used hitherto, especially those described in FR 2 815 374, particularly based on butyl rubber, are not entirely satisfactory in this regard—they constitute an overall satisfactory barrier to water in vapor form, but not to water in liquid form;
their processing, including the way in which they are laid on the edge of the devices, is not necessarily the simplest from the industrial standpoint; and
finally, their mechanical properties may be substantially inferior to what would be required.

Also known, from document U.S. Pat. No. 6,001,487, is a laminated window comprising two substrates between which an active system is placed, said window being provided with a peripheral sealing means comprising a polyisobutylene-based seal.

More particularly, when the active system is interposed between two thin substrates (with the thickness of each of the substrates being substantially close to 3 mm, or even much less (between 0.4 mm and 1.8 mm, preferably 0.7 mm)), the peripheral sealing means that has to provide a liquid-water sealing barrier and is generally applied by an encapsulation technique, runs the risk of damaging the window. This is because the thin substrates do not have mechanical properties sufficient to withstand the compressive forces generated by the molds and run the risk of breaking on the periphery, consequently resulting in the device incorporating the active system being off-specification.

Moreover, using thin laminated substrates greatly reduces the contact areas for bonding the peripheral seal. This is because optimum bonding of a peripheral seal applied by an extrusion and/or encapsulation technique is determined by the thickness of the glass sheet. It will be understood therefore that, for a thin substrate, the edge of the glass sheet reduces to virtually a line, which is manifestly of too small a thickness to allow optimum bonding of the seal.

The object of the invention is therefore to improve the design of the peripheral seals for the aforementioned laminated windows, especially as regards their chemical properties and/or their mechanical properties and/or their processing and/or their configuration relative to the substrates protecting the active systems.

The first subject of the invention is a laminated window, the various structures of which were described above, said window including an “active system” from among one of those mentioned above, which is placed between two thin substrates of said window. The invention consists in providing this window with a first peripheral sealing means for sealing the active system, in particular against water in vapor form, comprising at least one seal based on one or more hot-melt polymers chosen from at least one of the following polymer families: ethylene/vinyl acetate; polyisobutylene (butyl rubber); and polyamide, and a second sealing means, especially for sealing against liquid water, this second sealing means being positioned between the substrates and peripherally with respect to the first sealing means.

It is important to choose a polymer that is not only intrinsically impervious but which also adheres very well to the materials with which it is in contact, so as to avoid creating diffusion paths at the interface between the seal and the material to be sealed, and to avoid any delamination of the seal. Instead of or in addition to the use of such a bonding agent, the distribution of the molar masses present in the hot-melt polymer may also be varied, most particularly in the case of polyisobutylenes. By mixing several molar masses it is possible to achieve good creep resistance at temperature (in respect of the high molar masses) and also to achieve good adhesion to the materials to be sealed and good “tack” (in the case of low molar masses).

Overall, the first sealing means, within the meaning of the invention, is a hot-melt. It has a softening point at room temperature, a soft appearance and, owing to its viscosity, at this temperature, it is therefore possible to liquefy it in order to lay/form it at industrially acceptable temperatures.

They also have a viscosity of between 0.1 and 20 Pa.s, especially between 0.8 and 8 Pa.s, at 190° C.

Finally, they have a permeability to water in vapor form not exceeding 5 or 4 or 3 g/m²/24 h, in particular not exceeding 1 g/m²/24 h, according to the ASTM E 9663 T standard: this means that they are particularly impermeable to water.

The hot-melt polymers of the seals described above may be replaced with mastics, which are polymers behaving, when hot, like hot-melt polymers, but in which the transformation from the solid phase to the liquid phase is not reversible, unlike in hot-melts (as mastics are thermosets). The advantage of being able to install them in the window in the liquid phase also exists in the case of this family of mastics, provided that they are selected from those which crosslink only after they have been installed.

Most particularly preferred are polyurethane-based mastics, the water vapor permeability of which is equal to 4 g/m²/24 h or less, and is even close to 2 g/m²/24 h. PU-based mastics meeting the desired criteria (in particular having a water vapor permeability of 5 g/m²/24 h or less) are the mastics sold by Tremco under the reference IS442 (permeability of 5 g/m²/24 h) and by Le Joint Francais under the reference PU 3189/2 (permeability of 4 g/m²/24 h). The advantage of these particular mastics is that they provide both good water vapor impermeability and liquid water impermeability, although it is preferable to “line” the hot-melt-based seals with a second seal intended to serve as liquid water barrier. Mastics based on polysulfide or silicone may also be used.

To conclude with regards to the chemical nature of the polymers used in the first sealing means according to the invention, these hot-melt polymers are known to be used in very different applications, especially in the shoe industry and the cardboard box industry, and it proves to be the case that they are particularly advantageous in all the other technical fields pertinent to the invention.

Another flap of the invention relates to the possibility of also improving the mechanical strength of the seals, especially, but not exclusively, the hot-melt seals described above, for these laminated windows based on thin glass sheet. The subject of the invention is also the same type of substrate provided with a first peripheral sealing means, especially sealing with respect to water in vapor form, which comprises at least one polymer-based seal and is combined with a second sealing means providing both mechanical reinforcement means and/or means for setting the spacing between the two substrates between which the active system lies and sealing with respect to water in liquid form.

This is because it is necessary in a certain number of situations for the seal to have significant mechanical strength. This is most particularly the case when the device is in the form of a laminated window comprising two rigid or semi-rigid substrates that may be termed thin (with a thickness between 0.4 mm and 1.8 mm) between which the active system and one or more assembly polymer sheets are placed. In this case, one suitable configuration consists in ensuring that the assembly polymer sheet(s) (and also the active system itself) have smaller dimensions than those of the two substrates. Thus, a groove is created on the periphery of the window into which groove the one or more second sealing means may be housed. However, thanks to this configuration, it is possible to use a hot-melt seal (which provides no mechanical reinforcement) because of the simultaneous use of a second peripheral seal having a mechanical reinforcement property and a water barrier property.

Under these conditions, by using one or more peripheral seals it is possible to maintain the appropriate spacing between the two thin substrates on their periphery, preventing them from tending to bend in the “critical” peripheral zone of the groove, at least during the assembly operation.

In one embodiment of the sealing and reinforcing/setting second means, this may be in the form of a frame, especially made of a thermoplastic, of the lamination interlayer type, having a low melting point. The cross section of the frame may be square, rectangular, etc. This frame may be a one-piece frame or may be made of several parts that are placed end to end during laying. This second peripheral sealing means may rate the form of a thermoplastic polymer seal, for example made of polyvinyl butyral PVB, ethylene/vinyl acetate EVA, or one based on a sulfur-based polymer, based on polyethylene acrylate or EPDM, which is extruded like the butyl-based first sealing means, or made of certain polyurethanes. Advantageously, this seal may in fact be of the same chemical nature or of similar chemical nature to that of the thermoplastic interlayer sheets used for laminating the window.

It is thus possible to approach the structure of frames/spacers used for maintaining the spacing between the glass panes of standard double-glazing units.

The interlayer sheet or sheets are thus cut set back from the two glass panes, so as to create a peripheral groove for housing the seal(s) therein, and it is possible to ensure that the groove is provided with one or both seals as described above. The “filling” of the groove is then completed with a strip of thermoplastic polymer of the same origin as the interlayer sheets. These strips correctly fulfill the liquid impermeability role and are made of an already available material since this is used to make the interlayers. This is a simple and effective solution, that of thus “diverting” the thermoplastic sheets so as to make them act as complementary seals. This thermoplastic seal is preferably continuous over the entire window, but it may also be discontinuous. It thus “traps” the other seal(s) placed in front of it in the peripheral groove.

In that case, the first and second sealing means of the device preferably comprise seals that are juxtaposed. For example, two types of seal having different chemical formulations may be co-injected/co-extruded. It is also possible to deposit two pre-extruded or precast or precut beads side by side. Arrangements may be made for all the seals to be housed in the peripheral groove described above. This therefore gives a device whose sealing function is flush with the substrates and does not “project” therefrom, which arrangement is both attractive and practical when mounting the substrate in motor vehicles, aircraft (used as cabin windows) or buildings, or in displays.

In general, these sealing/mechanical reinforcing means are laid on one of the substrates of the device, before its assembly with the other substrate (the case of the abovementioned beads).

It is also possible to use a single seal provided that its chemical nature makes it satisfactorily impermeable both to liquid water and to water vapor.

Advantageously, the sealing/reinforcing means used within the context of the invention are placed so as not to have any contact with the electronically conducting layers of the active system.

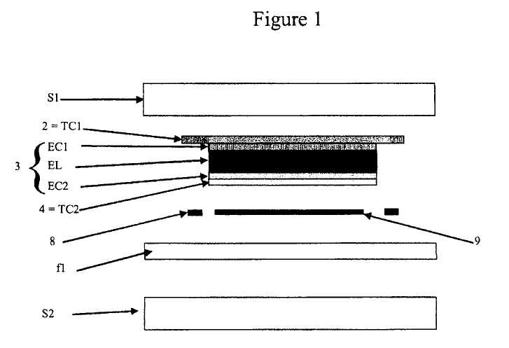

The invention will be described below in greater detail with the following non-limiting examples, with the aid of FIGS. 1, 2 and 3. These figures show, highly schematically, a laminated electrochromic window sealed according to the invention. The examples all relate to an “all-solid-state” electrochromic window.

In the appended drawings, certain elements may be shown on a larger or smaller scale than in reality, so as to make it easier to understand the figures.

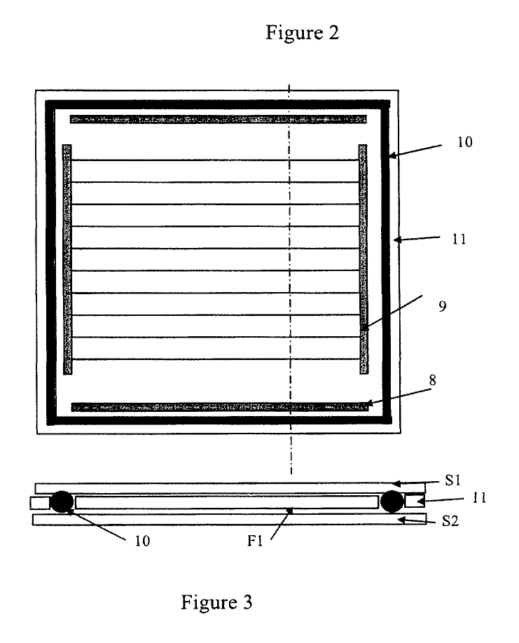

The example illustrated by FIGS. 1 and 2 relates to an electrochromic window 1. It comprises, in succession from the inside to the outside of the passenger compartment, two thin glass panes S1, S2, which are clear soda-lime-silica glass panes (but they may also be tinted), with a thickness for example of 0.4 mm and 1.8 mm respectively.

The glass panes S1 and S2 are of the same size, with dimensions of 150 mm×150 mm.

The glass pane S1 is laminated to the glass pane S2 via a thermoplastic sheet f1 made of polyurethane (PU) 0.8 mm in thickness (it may be replaced with a sheet of ethylene/vinyl acetate (EVA) or polyvinyl butyral (PVB)) sandwiching an electrochromic-type thin-film multilayer 3.

The electrochromic thin-film multilayer may be of the “all-solid-state” type and it comprises for example an active multilayer 3 placed between two electronically conducting materials, also called current collectors 2 and 4. The collector 2 is intended to be in contact with face 2.

The collectors 2 and 4 and the active multilayer 3 may either be of substantially the same dimensions and shape, or substantially different dimensions and shape, and it will be understood therefore that the path of the collectors 2 and 4 will be adapted according to the configuration. Moreover, the dimensions of the substrates, in particular of SI, may be essentially greater than those of 2, 4 and 3.

The collectors 2 and 4 are of the metallic type or of the TCO (Transparent Conductive Oxide) type, made of In₂O₃:Sn (ITO), SnO₂:F or ZnO:Al, or a multilayer of the TCO/metal/TCO type (it being possible for these TCOs to be chosen from those mentioned above), the metal being chosen in particular from silver, gold, platinum and copper. It may also be a multilayer of the NiCr/metal/NiCr type, the metal also being chosen in particular from silver, gold, platinum and copper.

Depending on the configurations, they may be omitted, and in this case current leads are directly in contact with the active multilayer 3.

The window 1 incorporates current leads 8, 9, which allow the active system to be controlled via an electrical supply. These current leads are of the type of those used for heated windows (namely shims, wires or the like).

One preferred embodiment of the collector 2 consists in depositing, on face 2 (it will be recalled that the system for numbering the faces is: 1, the outer face of S1; 2, the inner face of S1; 3, the inner face of S2; and 4, the outer face of S2 directed toward the interior of an enclosure), a 50 nm SiOC first layer surmounted by a 400 nm SnO₂:F second layer (both layers preferably being deposited in succession by CVD on the float glass before cutting).

A second embodiment of the collector 2 consists in depositing, on face 2, a bilayer consisting of an approximately 20 nm SiO₂-based first layer which may or may not be doped (especially doped with aluminum or boron) surmounted by an approximately 100 to 600 nm ITO second layer (both layers preferably being vacuum-deposited in succession by magnetron reactive sputtering in the presence of oxygen, optionally carried out hot).

Another embodiment of the collector 2 consists in depositing, on face 2, an approximately 100 to 600 nm monolayer consisting of ITO (a layer preferably vacuum-deposited by magnetron reactive sputtering in the presence of oxygen, optionally carried out hot).

The collector 4 is a 100 to 500 nm ITO layer again deposited by magnetron reactive sputtering on the active multilayer.

The active multilayer 3 is made up as follows, according to a first embodiment:
a 100 to 300 nm layer of anodic electrochromic material made of nickel oxide, which layer may or may not be alloyed with other metals;
a 100 nm layer of hydrated tantalum oxide or hydrated silica oxide or hydrated zirconium oxide, or a mixture of these oxides; and
a 200 to 500 nm, preferably 300 to 400 nm, especially about 370 nm, layer of cathodic electrochromic material based on tungsten oxide.

According to a second embodiment, the active multilayer 3 is made up as follows:
a 100 to 300 nm layer of anodic electrochromic material made of nickel oxide, which layer may or may not be alloyed with other metals;
a 100 nm layer of hydrated tungsten oxide;
a 100 nm layer of hydrated tantalum oxide or hydrated silica oxide or hydrated zirconium oxide or a mixture of these oxides; and
a 200 to 500 nm, preferably 300 to 400 nm, especially about 370 nm, layer of cathodic electrochromic material based on hydrated tungsten oxide.

According to a third embodiment, the active multilayer 3 is made up as follows:
a 70 to 100 nm layer of anodic electrochromic material made of iridium oxide, which layer may or may not be alloyed with other metals;
a 100 nm layer of hydrated tungsten oxide;
a 100 nm layer of hydrated tantalum oxide or hydrated silica oxide or hydrated zirconium oxide or a mixture of these oxides; and
a 200 to 500 nm, preferably 300 to 400 nm, especially about 370 nm, layer of cathodic electrochromic material based on hydrated tungsten oxide.

The active multilayer 3 may be incised over all or part of its periphery with grooves produced by mechanical means or by etching using laser radiation, optionally pulsed laser radiation, for the purpose of limiting peripheral electrical leakage, as described in French application FR-2 781 084.

In other embodiments, the “all-solid-state” active multilayer 3 may be replaced with other families of electrochromic materials of the polymer type.

Thus, for example, a first part formed from a 10 to 10 000 nm, preferably 50 to 500 nm, layer of electrochromic material, also called the active layer, made of poly(3,4-ethylenedioxythiophene)—as a variant it may be one of the derivatives of this polymer—is deposited by known liquid deposition techniques (spray coating, dip coating, spin coating or casting), or by electrodeposition, on a substrate coated with its current collector, it being possible for this current collector to be a lower conducting layer or an upper conducting layer forming the electronic conductor (the anode or the cathode), optionally provided with wires or the like. Whatever the polymer constituting this active layer, this polymer is particularly stable, especially to UV, and operates by insertion/ejection of lithium ions (Li⁺) or alternatively of H⁺ ions.

A second part acting as electrolyte, and formed from a layer with a thickness of between 50 nm and 2000 μm, and preferably between 50 nm and 1000 μm, is deposited by a known liquid deposition technique (spray coating, dip coating, spin coating or casting) between the first and third parts on the first part or else by injection.

This second part is based on a polyoxyalkylene, especially polyoxyethylene. It may be combined with a layer of mineral-type electrolyte, for example based on hydrated tantalum oxide, zirconium oxide or silicon oxide.

This second electrolyte part deposited on the active layer of electrochromic material, itself supported by the glass or similar substrate, is then coated with a third part, the constitution of which is similar to the first part, namely this third part is made up of a substrate coated with a current collector (conducting wires, or conducting wires plus conducting layer, or only conducting layer), this current collector itself being covered with an active layer.

This example corresponds to a window operating by proton transfer. It consists of a first glass substrate S1, made of 0.8 mm soda-lime-silica glass, followed in succession by:
a 300 nm electronically conducting first SnO₂:F layer;
a 185 nm anodic first layer of electrochromic material made of hydrated nickel oxide NiOₓH_{y} (it could be replaced with a 55 nm layer of hydrated iridium oxide);
an electrolyte made up of a 70 nm first layer of hydrated tantalum oxide, a 100 micron second layer of POE/H₃PO₄ polyoxyethylene/phosphoric acid solid solution or alternatively a PEI/H₃PO₄ polyethylene imine/phosphoric acid solid solution; combined with
a 100 nm layer of hydrated tantalum oxide or hydrated silica oxide or hydrated zirconium oxide or a mixture of these oxides;
a 350 nm second layer of cathodic electrochromic material based on tungsten oxide; and
a 300 nm second SnO₂:F layer followed by a second glass substrate identical to the first.

In this example, there is therefore a bilayer electrolyte based on a polymer normally used in this type of glazing, which is “lined” with a layer of hydrated tantalum oxide that is sufficiently conducting not to impair proton transfer via the polymer and that protects the counterelectrode made of anodic electrochromic material from direct contact with the latter, the intrinsic acidity of which would be prejudicial thereto.

Instead of the hydrated Ta₂O₅ layer, a layer of the hydrated Sb₂O₅ or TaWOₓ type may be used.

It is also possible to provide a three-layer electrolyte, with two hydrated oxide layers, either with one of them on each side of the polymer layer, or with the two layers superposed one on the other on the side facing the layer of anodic electrochromic material.

Whatever the type of active system, the window shown in FIGS. 2 and 3 incorporates a first peripheral seal in contact with faces 2 and 3, this first seal 10 being designed to provide a barrier to external chemical attack and a water vapor barrier.

One example of the formulation for this first seal is the following:
an ethylene/vinyl acetate base, containing 5 to 40% vinyl acetate and 40 to 95% ethylene (this is especially the EVA sold by National Starch under the name “Instant Pak 2300” or the EVA sold by TRL under the name “Thermelt 2147/2157”), it being possible for this base to contain at least one of the following additives:
a tackifying resin;
a crosslinking agent; and
a filler.

This type of formulation gives a first seal 10 that is both remarkably impermeable to water vapor and highly adherent to glass, making it very effective.

Alternatively, it is possible to use, instead of the EVA-based seal, a seal based on a polyamide or a polyisobutylene or a butyl rubber.

In the above example, the seal is a hot-melt seal. It is soft at room temperature or can be melted and then injected under pressure into the peripheral groove of the window once assembled. It may also be laid around the periphery of the glass pane S1 before it is assembled with the glass pane S2, the lamination operation setting the desired cross section under the effect of pressure and possibly heat.

A second peripheral seal 11 is in contact with face 2 of S1 and with face 3 of S2 and is positioned around the periphery of the first seal 10. It provides a liquid water sealing barrier and a means for mechanically reinforcing the peripheral groove, preventing the thin substrates from breaking during lamination or during successive handling operations.

This second seal 11 goes around the first seal 10 and seals against liquid water. It may be deposited:
by extrusion of a polyurethane (PU) or any thermoplastic elastomer (TPE) polymer;
by reactive injection molding (RIM) of a PU;
by thermoplastic injection molding of a polyvinyl chloride (PVC)/TPE blend;
by injection molding and vulcanization of ethylene propylene diene monomer (EPDM) terpolymer; and
by deposition of a frame or a portion of a frame made from a thermoplastic similar to that used for the lamination interlayers.

The second seal may also be a strip of PU, EVA, PVB, or polyethylene acrylate, for example of the same kind as that of the thermoplastic interlayer sheet.

The second seal may be laid simultaneously with or after the first seal, before or after assembly of the window. It may be “protruding”, covering the edges of the two glass panes, or bonded to the first seal in the peripheral groove of the window so that together the two seals are flush in the final laminated window.

The invention has therefore provided a novel chemical seal formulation and a novel means for mechanically reinforcing it. These sealing and mechanical reinforcing means are effective whenever it is required to protect layers/elements between two substrates that are sensitive to water (liquid and/or vapor) or to gases such as oxygen, and, in general, to any exposure to the atmosphere.

The invention also makes it possible to simplify the manufacturing process, the seals being positioned during the lamination operation—it is no longer necessary to carry out the encapsulation operation after lamination.

Of course, it is also possible to use them for windows having an active system operating in reflection (electrochromic mirror of the rearview mirror type for example), for windows in which the thermoplastic interlayer is replaced with a double-sided adhesive polymer film.

They also apply to non-glass substrates. They may also apply to active systems requiring peripheral sealing but not in the form of laminated glazing (double glazing, system with no rigid substrate, etc.).

Thus, they may also be applied to windows for which the active multilayer occupies only a small portion of the total area of the window (for example a sunscreen band, etc.) or more generally any type of window in which the active, especially electrochromic, system is only one accessory element within the entire window. In this case, the PU and its first peripheral sealing means are necessary only for the zones covered by the active system, the second sealing/reinforcing means, especially based on EVA or PVB, being sufficient for the conventional zones.

According to yet another preferred embodiment of the invention, the laminated window described above may be used as a facade in front of a vehicle instrument panel. When positioned in front of the latter and when the active system is colored, it obscures the instrument panel, consequently masking the information or the various dials (revolution counter, speed indicator, temperature indicator, display screen, clock, etc.) not appearing on the instrument panel. This colored state of the active system gives the entire fascia a particularly attractive rendition (in general, this situation constitutes the position in which the vehicle is at rest).

In contrast, in the bleached state of the active system, the laminated window positioned as a facade in front of the instrument panel does not hamper the driver's vision of the information coming from the instrument panel, the functionality of which is not affected. It may be noted that the invention has the particular advantage over the solutions of the prior art, which generally consist of facades made of tinted glass, of not having to overdimension the instrument panel information systems which must nevertheless ensure that this information can be seen, despite the tinted facade, such overdimensioning resulting in the display devices consuming an excessive amount of power and heating up excessively.

It is also possible to use the laminated window according to the invention, again positioned as a facade in front of the screens of an instrument panel, as a head-up display (HUD) screen.

To guarantee that the information projected on this screen is correctly viewed, the laminated window is combined with a third, back-glass that is superposed with it. To prevent the virtual image projected onto and displayed on this screen from being distorted owing to the various reflections inherent in the reflective properties of glass (different faces), and owing to the relative position of the user with respect to the plane of the image, the back-glass is superposed with the laminated window according to the invention by interposing a wedge PVB sheet.

The operation of the head-up display screen is the following:

In the colored state of the active system, the projected image is reflected by the screen and becomes visible, without optical distortion, by the driver.

In the bleached state of the active system, the projected (or non-projected) image is not reflected by the screen positioned as a facade in front of the instrument panel, and the usual information from the indicators, counters and the like on the instrument panel appears normally.

1: A laminated window comprising two thin substrates (S1, S2) between which an active system (3) is placed, characterized in that the window is provided with a first peripheral sealing means (10) for sealing the active system, in particular against water in vapor form, comprising at least one seal based on one or more hot-melt polymers chosen from at least one of the following polymer families: ethylene/vinyl acetate, polyisobutylene, butyl rubber and polyamide, and a second sealing means (11), especially for sealing against liquid water, this second sealing means being positioned between the substrates (S1, S2) and peripherally with respect to the first sealing means (10), this second sealing means (11) being at least one frame portion produced from a sheet of thermoplastic.

2: The window as claimed in claim 1, characterized in that the sheet of thermoplastic is based on EVA, PU, PVB, polyethylene acrylate or sulfur-containing polymers, especially of the same kind as the interlayer polymer sheet(s) used for laminating said window.

3: The window as claimed in claim 1, characterized in that the active system (3) is an electrochemical system, especially an electrically controllable system having variable energy/optical properties, such as an all-solid-state or polymeric electrochromic system, an optical-valve system, a liquid-crystal system, a viologen-based system, a photovoltaic system or an electroluminescent system.

4: The window as claimed in claim 1, characterized in that the active system (3) is a thermochromic, thermotropic, photochromic, solar-control or low-emissivity layer or multilayer.

5: The window as claimed in claim 1, characterized in that it is in the form of a laminated window with two rigid or semi-rigid substrates (S1, S2) between which is the electroactive system (3) surmounted by at least one interlayer sheet (f1) based on a thermoplastic polymer.

6: The window as claimed in claim 5, characterized in that the interlayer sheet(s) (f1) has (have) smaller dimensions than those of the two substrates (S1, S2) so as to create a peripheral groove between said substrates, the seal(s) of the first peripheral sealing means (10) and of the second sealing means (11) being at least partly, and preferably entirely, housed in said groove.

7: The window as claimed in claim 1, characterized in that the seal(s) of the first peripheral sealing means (10) has (have) a softening point at room temperature.

8: The window as claimed in claim 1, characterized in that the seal(s) of the first peripheral sealing means (10) has (have) a viscosity of between 0.1 and 20 Pa.s, especially between 0.8 and 8 Pa.s, at 190° C.

9: The window as claimed in claim 1, characterized in that the seal(s) of the first peripheral sealing means (10) has (have) a permeability to water in vapor form not exceeding 5 or 4 or 3 g/m2/24 h according to the ASTM E 9663 T standard.

10: The window as claimed in claim 1, characterized in that the seal(s) of the first peripheral sealing means (10) is (are) laid by extrusion or injection in the liquid phase.

11: The window as claimed in claim 1, characterized in that the first and second peripheral sealing means (10, 11) comprise seals that are juxtaposed.

12: The window as claimed in claim 1, characterized in that all of the seals of the peripheral sealing means (10, 11) are housed in the peripheral groove present between the two substrates (S1, S2) owing to the shrinkage of the thermoplastic-polymer-based interlayer sheet or sheets, especially so as to obtain flush seals.

13: The window as claimed in claim 1, characterized in that it constitutes a window for motor vehicles, aircraft or buildings.

14: The window as claimed in claim 1, characterized in that it constitutes a facade positioned in front of a vehicle instrument panel.

15: The window as claimed in claim 14, characterized in that it is used as an HUD (head-up display) screen.
